(19) United States
(12) Patent Application Publication
(10) Pub. No.: US 2007/0056370 A1
(43) Pub. Date: Mar. 15, 2007

(54) MEMS SENSOR PACKAGE

(75) Inventors: Todd L. Braman, New Brighton, MN (US); Drew A. Karnick, Blaine, MN (US); Max C. Glenn, Chanhassen, MN (US); Harlan L. Curtis, Champlin, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, MN (US)

(21) Appl. No.: 11/161,871

(22) Filed: Aug. 19, 2005

(51) Int. Cl. G01P 1/00; G01P 21/00

(52) U.S. Cl. 73/514.07; 73/1.38

(57) ABSTRACT

Methods and systems for controlling the internal dampening of MEMS sensors is provided. In one illustrative embodiment, a MEMS sensor is provide that can be tunable to a desired Q value, and the Q value may be held relatively constant over the expected life of the sensor. The MEMS sensor package may include a chamber that houses a MEMS sensor. An inert gas may be provided in the chamber at a desired or specified pressure, wherein the inert gas may be backfilled into the chamber after the chamber is evacuated. The pressure of the inert gas may be set to achieve a desired Q value.

### FIELD

The present invention relates generally micro-electro-mechanical systems (MEMS) sensors, and more particularly, to methods and systems for controlling the internal dampening of such sensors.

### BACKGROUND

The operational performance of some MEMS sensors, such as MEMS gyro sensors, is related to the quality (Q) value of the sensor. The Q value of the sensor may be a function of the pressure in the sensor package. The Q value may affect operation characteristics of the MEMS sensor, including, for example, the start-up time of the sensor, the ring-down time of the sensor, the sensitivity of the sensor, as well as other performance characteristics. In some applications, such as guidance of missiles or other projectiles, it may be desirable to have a MEMS sensor with a relatively low attenuation, yet have a quick enough ring-down time to provide adequate response after a shock event. Also, maintaining a relatively constant Q value over the expected life of the sensor, sometimes extending 20 or more years, would also be desirable.

Traditional MEMS gyro sensors operate with a pressure of 5-10 mTorr in the sensor package. This pressure may result in a Q value of approximately 60,000. This Q value may provide an adequate response time following a shock or other event, and a marginally adequate sensitivity for the sensor. However, leaks and/or out gassing in the sensor package may degrade the performance, and the Q value, of the MEMS sensor over time. The leaks and/or out gassing tend to cause the pressure in the sensor cavity to rise over the life of the MEMS sensor, decreasing the sensitivity of the sensor. In some cases, this may shorten the useful lifetime of the MEMS sensor.

To help mitigate the effect of leaks and out gassing in the sensor cavity, a getter may be introduced into the cavity. The getter may absorb most of the non-inert gas in the sensor chamber. However, the addition of the getter may reduce the pressure in the chamber from 5-10 mTorr to about 1 mTorr. This lower pressure may increase the Q value of the sensor, in some cases, to a value of about 80,000 or greater. This high Q value may provide high sensitivity for the sensor, but it also increases the start up time and the ring-down time following a shock or other event. The ring down time for such a sensor may be anywhere from 2 to 4 seconds, which for some applications, may not be acceptable. Additionally, and because of the low pressure in the chamber (e.g. 1 mTorr), any gas that is not absorbed by the getter may result in a relatively large percentage change in pressure in the sensor chamber, which may produce a relatively large change in the Q value and performance of the MEMS sensor. That is, the Q value of the sensor may be particularly sensitive to small leaks and/or out gassing in the sensor package because of the low initial pressure inside the chamber.

### SUMMARY

The following summary of the invention is provided to facilitate an understanding of some of the innovative features unique to the present invention and is not intended to be a full description. A full appreciation of the invention can be gained by taking the entire specification, claims, drawings, and abstract as a whole.

The present invention relates generally micro-electro-mechanical systems (MEMS) sensors and more particularly to methods and systems for controlling the internal dampening of such sensors. In one illustrative embodiment, a MEMS sensor is provide that can be tunable to a desired Q value, and the Q value may be held relatively constant over the expected life of the sensor. The MEMS sensor package may include a chamber that houses a MEMS sensor. An inert gas may be provided in the chamber at a desired or specified pressure, wherein the inert gas may be backfilled into the chamber after the chamber is evacuated. The pressure of the inert gas may be set to achieve a desired Q value.

Also, the pressure in the chamber may be elevated sufficiently so that small leaks do not have a significant impact on the pressure, and thus the Q value of the MEMS sensor. The MEMS package may include a getter situated inside the chamber that may absorb non-inert gas. Thus, and in some cases, the getter may absorb residual non-inert gasses from the chamber and/or non-inert gas that may leak into the chamber. In one case, the inert gas may be argon, but it is contemplated that any other suitable inert gases may be used. In the illustrative MEMS package, the pressure of the inert gas may be higher than the pressure of any non-inert gas, and in some cases, significantly higher. For example, and in one case, the pressure may be 18 mTorr, resulting in a Q value for the MEMS device of about 45,000. The MEMS sensor may be a MEMS gyro sensor.

In another illustrative embodiment, a method of packaging a MEMS sensor is provided. The MEMS sensor may be provided in a chamber with a getter that absorbs non-inert gas. The illustrative method may include evacuating the chamber, backfilling the chamber with an inert gas, and sealing the chamber. The chamber may be backfilled with a desired pressure of inert gas, preferably greater than any expected non-inert gas in the chamber. In some cases, the chamber may be backfilled with, for example, 18 mTorr of inert gas. In one case, the inert gas may be argon, but this is not required. The illustrative MEMS gyro sensor may have a life of 15 years or greater.

In yet another illustrative embodiment, a method of setting a Q value for a MEMS sensor is provided. The MEMS sensor may be provided in a chamber. The method may include identifying a predetermined pressure that will result in a desired Q value of the MEMS sensor, evacuating the chamber, backfilling the chamber with the predetermined pressure of inert gas, and sealing the chamber. In some cases, the illustrative method may further include providing a getter to help maintain a relatively constant pressure and thus Q value over the expected life of the MEMS gyro sensor, wherein the getter may absorb non-inert gas. In some cases, the step of identifying a predetermined pressure that will result in a desired Q value of the MEMS sensor may include determining a desired ring-down time of the MEMS gyro sensor, and/or determining a desired sensitivity of the MEMS gyro sensor. In some cases, the chamber may be backfilled with a pressure of inert gas greater than the pressure of any expected non-inert gas in the chamber, if desired.

### BRIEF DESCRIPTION

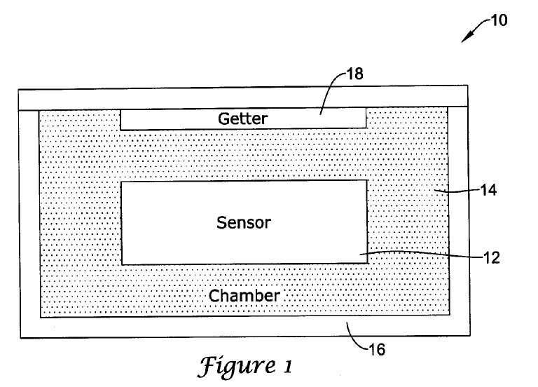

FIG. 1 is a schematic diagram of an illustrative MEMS sensor package;

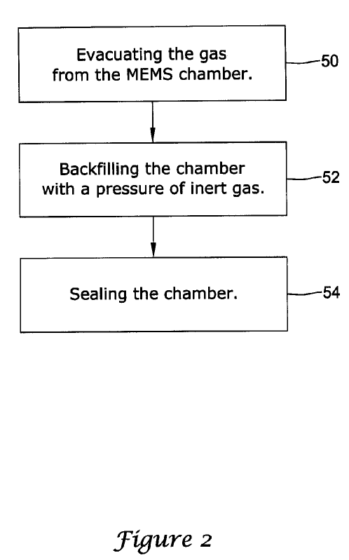

FIG. 2 is a flow diagram of an illustrative method of providing a MEMS sensor with a constant Q over time;

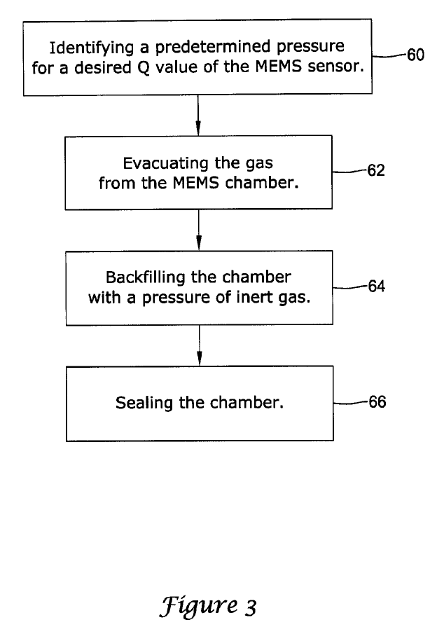

FIG. 3 is a flow diagram of an illustrative method of setting a Q value of the illustrative MEMS sensor;

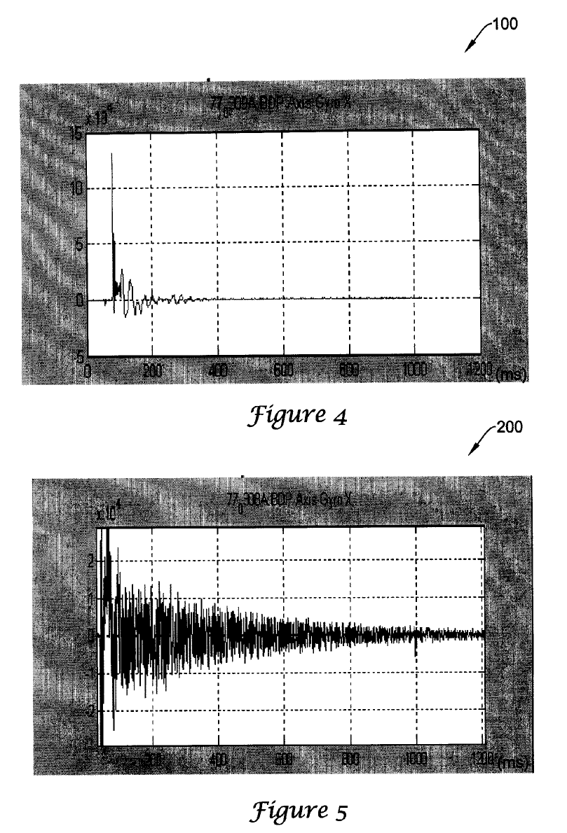

FIG. 4 is a graph showing a ring-down time of the illustrative MEMS gyro sensor having a Q value of about 65,000;

FIG. 5 is a graph showing a ring-down time of the illustrative MEMS gyro sensor having a Q value of about 80,000;

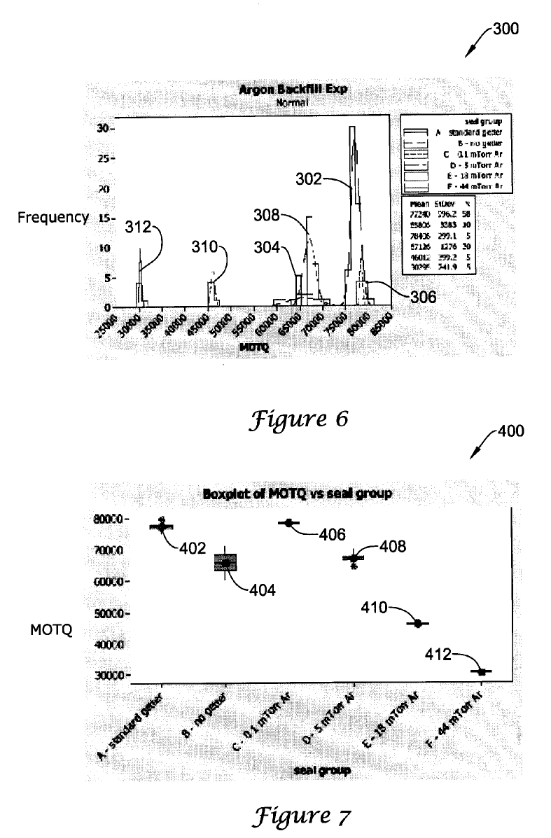

FIG. 6 is a graph showing an illustrative histogram plot of motor Q versus the number of samples in a particular Q bin; and

FIG. 7 is a graph showing an illustrative plot of motor Q versus chamber pressure.

### DETAILED DESCRIPTION

The following description should be read with reference to the drawings wherein like reference numerals indicate like elements throughout the several views. The detailed description and drawings show several embodiments which are meant to be illustrative of the claimed invention.

FIG. 1 is a schematic diagram of an illustrative MEMS sensor package 10. The illustrative MEMS sensor package 10 includes a package body that defines a chamber 16, a MEMS sensor 12 situated in the chamber 16, and a getter 18 exposed to the chamber 16. The getter may be adapted to absorb non-inert gases, while not absorbing inert gases. The MEMS sensor 12 may be tunable to a desired Q value by controlling the pressure in the chamber 16 over time, and may have a relatively constant Q value over the life of the sensor 12 by surrounding the movable portions of the MEMS sensor 12 with an appropriate pressure of inert gas, which is generally shown at 14.

In some illustrative embodiments, the MEMS sensor 12 may be a MEMS gyro sensor. However, any sensor with vibrating or moving parts that have performance characteristics based on a Q value may be used, as desired. The chamber 16 is sized to house the MEMS sensor 12, and may be defined by internal walls of the body of the MEMS sensor package 10.

In some cases, the inert gas 14 in the chamber 16 may be argon. However, it is contemplated that any inert gas 14 may be used, as desired. The inert gas 14 may be backfilled into the chamber 16 after the chamber 16 has been evacuated to a relatively low pressure. In some cases, the chamber 16 may first be evacuated by pulling a vacuum or near vacuum. In another case, an inlet and outlet may be provided in the chamber 16, where in order to fill the chamber 16 with the inert gas 14, the inert gas 14 is pumped into the chamber 16 through the inlet, thereby displacing any non-inert gas and forcing the non-inert gas out of the chamber through the outlet. Other techniques may also be used to fill the chamber 16 with an inert gas.

The pressure of inert gas 14 in the chamber 16 may be any suitable pressure as desired. In some cases, the pressure of the inert gas 14 may be greater, and in some cases, significantly greater, than the pressure of any remaining non-inert gas, including any non-inert gas that may leak or out gas into the chamber over the expected life of the MEMS sensor 12. This may help decrease any change in the Q value of the MEMS sensor 12 over the expected life of the MEMS sensor 12. In some cases, the pressure of inert gas 14 may be at least 5 mTorr, yet in other cases, the pressure of the inert gas 14 may be greater such as approximately 18 mTorr, or less, as desired. More generally, the pressure of inert gas 14 in the chamber 16 may be any suitable pressure as desired.

In the illustrative MEMS sensor package 10, a getter 18 may be provided to absorb non-inert gas. The getter 18 may absorb residual gas that may not have been evacuated from the chamber 16 and/or the getter 18 may absorb gas that may leak or outgas into the chamber 16 during the life of the sensor 12. In some cases, the getter 18 may absorb approximately 95% or more of the gas that enters the chamber 16, as approximately 95% of any gas that leaks or out gasses into the chamber may be a non-inert gas.

As a result, the illustrative MEMS sensor 12 may have a relatively constant Q value over the expected life of the MEMS sensor 12. In some cases, the MEMS sensor 12 may have a longer life than traditional MEMS sensors 12, such as 15 years, 20 years, or even longer. To maintain the relatively constant Q value, the pressure surrounding the MEMS sensor 12 should also be relatively constant. By providing a getter 18, which may absorb any residual gas and/or gas that may leak into the chamber 16, the pressure change may be held relatively small. Also, by backfilling the chamber 16 with an inert gas, thus raising the desired pressure in the chamber 16 (e.g. having a higher pressure greater than 1 mTorr, or even 5 mTorr) a small leak or out gassing into the chamber 16 may result in a relatively small percentage change in pressure. As such, the Q value may be held relatively constant over the expected life of the sensor.

In some embodiments, the MEMS sensor 12 may be tunable to a desired Q value. By determining the relationship between the Q value and pressure, for a particular MEMS sensor 12, a pressure may be determined in advance, and the package chamber 16 may be backfilled with an inert gas to that pressure to achieve the desired Q value. By backfilling with an inert gas 14 and/or providing a getter 18, the MEMS sensor package 10 may hold the pressure at a relatively constant value over time, which may result in a relatively constant Q value over time.

FIG. 2 is a flow diagram of an illustrative method of providing a MEMS sensor with a relatively constant Q over time. The illustrative method includes providing a MEMS sensor, the MEMS sensor being housed in a chamber with a getter that absorbs non-inert gas. Referring specifically to FIG. 2, the chamber is first evacuated to a desired pressure, as shown at step 50. The chamber may be evacuated to remove the non-inert gas which, if not removed, may be absorbed by the getter (once activated), thereby decreasing the pressure and changing the Q value over time. The chamber may be evacuated by pulling a vacuum or near vacuum, if desired. Next, the chamber is backfilled with an inert gas as shown at step 52. The chamber may be backfilled with a pressure of inert gas. By providing a backfill of inert gas, which the getter may not absorb, the Q value may be more constant over the expected life of the MEMS sensor. Backfilling the chamber so that the resulting pressure in the chamber is higher, such as 10 or 20 mTorr, an amount of gas leaking or out gassing into the chamber may result in a relatively small percentage change in the pressure in the chamber, and may thus have a relatively small impact on the Q value of the MEMS sensor. In one illustrative case, the chamber may be backfilled to a pressure of about 18 mTorr, which may result in a Q value of about 45,000, but this is only an example. Next, the chamber is sealed at step 54.

It is contemplated that the getter in the chamber may be activated prior to pulling a vacuum or near vacuum, while pulling a vacuum or near vacuum, or after the chamber is sealed. In some cases, the getter may be activated by applying heat to the getter.

FIG. 3 is flow diagram of an illustrative method of setting a Q value of a MEMS sensor. The illustrative method includes identifying a predetermined pressure that will result in a desired Q value of the particular MEMS sensor, as shown at step 60. The chamber that houses the MEMS sensor may then be evacuated to a desired low pressure level, as shown at step 62. The chamber may then be backfilled with the predetermined pressure of inert gas, as shown at step 64, and the chamber may then be sealed, as shown at step 66. In some cases, the illustrative method may include providing a getter in the chamber to maintain a relatively constant pressure and thus Q value over the expected life of the MEMS sensor, wherein the backfilled gas may be an inert gas and the getter may only absorbs non-inert gas. The getter may be activated prior to evacuating the chamber, while evacuating the chamber, or after the chamber is evacuated and/or sealed. More generally, the getter may be activated at any time, as desired. In some cases, the getter may be activated by applying heat.

The identified predetermined pressure for the desired Q value of the MEMS sensor 62 may be dependant on many performance characteristics of the MEMS sensor, such as the desired ring-down time and the desired sensitivity of the MEMS sensor, as well as other characteristics. Thus, the step of identifying a predetermined pressure for a desired Q value of the MEMS sensor may include determining a desired ring-down time of the MEMS gyro sensor, and/or determining a desired sensitivity of the MEMS gyro sensor, and/or any other characteristics as desired. The ring-down time is the time that it takes the MEMS sensor to ring-down after a shock or other event. A high Q value will tend to have a slow ring-down time, and a lower Q value will tend to have a faster ring-down time. The sensitivity of the MEMS sensor may be greater for a higher Q value than for a lower Q value, so there is often a trade off between ring down time and sensitivity. Different applications may require different Q values, and thus different desired inert gas pressures for the MEMS sensor may be provided.

In one example, for some ballistic applications, the identified predetermined pressure may be about 18 mTorr, which may provide a Q value of about 45,000 for some MEMS gyro sensors. This may result in a ring-down time of about 50 milliseconds or less while still providing sufficient sensitivity for providing guidance information for the ballistic projectile. Therefore, the Q value of the MEMS sensor may be set to any desired value by backfilling the chamber with an inert gas at a desired pressure.

FIG. 4 is a graph showing a ring-down time of an illustrative MEMS gyro sensor having a Q value of about 65,000. The ring-down time for the illustrative MEMS gyro sensor is the time that it takes the gyro to stop oscillating/vibrating after a specified shock event. During the ring-down period, gyro sensor data is typically not taken because it is deemed to be invalid. Therefore, the system may have to wait for a period of time after a shock or other event before data can be validly read from the MEMS gyro sensor. The illustrative graph shows the ring-down time of a MEMS gyro that has a pressure of 5 to 10 mTorr in the sensor chamber, resulting in a Q value of about 65,000.

FIG. 5 is a graph showing a ring-down time of an illustrative MEMS gyro sensor having a Q value of about 80,000. To achieve the Q value of 80,000, the pressure in the sensor chamber was set to about 1 mTorr. The ring-down time shown in FIG. 5 is much longer than that shown in FIG. 4. As illustrated between FIG. 4 and FIG. 5, the higher the pressure, the quicker the ring-down time of the MEMS gyro sensor. For some applications, a quick ring-down time may be desirable. Thus, a lower Q value may be desirable. However, for higher pressures, the sensitivity of the MEMS sensor tends to be lower. As such, and as indicated above, there is often a trade off between ring down time and sensitivity.

FIG. 6 is a graph 300 showing motor Q versus the number of samples in a particular Q bin. The data was taken with several MEMS gyro samples representing a variety of different pressures in the chamber. The first group of data, generally shown at 302, was taken with a getter in the sensor chamber having a pressure of about 0.1 mTorr. The first group 302 has a mean Q value of about 77,000, and a motor frequency of about 28 Hz. The second group of data, generally shown at 304, was taken with no getter in the package having a pressure of 5-6 mTorr. Second group 304 has a mean Q value of about 65,000 with a motor frequency of about 10 Hz. The third group of data, generally shown at 306, corresponds to a sensor chamber that is backfilled with a pressure of 0.1 mTorr of argon. The mean Q value is about 78,000 with a motor frequency of about 29 Hz. The fourth group of data, generally shown at 308, corresponds to a sensor chamber backfilled with a pressure of 5 mTorr of argon. The mean Q value is about 67,000 with a motor frequency of about 15 Hz. The fifth group of data, generally shown at 310, corresponds to a sensor chamber backfilled with a pressure of 18 mTorr of argon. The mean Q value is about 46,000 with a motor frequency of about 5 Hz. The sixth group of data, generally shown at 312, corresponds to a sensor chamber backfilled with a pressure of 44 mTorr of argon. The mean Q value is about 30,000 with a motor frequency of about 4 Hz. As clearly illustrated, the larger the Q value of the sensor, the higher the operating motor frequency of the MEMS gyro sensor. The sensitivity of the sensor is typically related to the operating motor frequency of the sensor.

FIG. 7 is a graph 400 showing an illustrative plot of motor Q versus chamber pressure. This graph 400 shows the relationship between the pressure in the chamber and the Q value of the MEMS sensor. Point 402 corresponds to a sensor chamber with a pressure of about 0.1 mTorr and a getter, resulting in a Q value for the MEMS sensor of about 77,000. Point 404 corresponds to a sensor chamber with a pressure of about 5 mTorr and no getter, resulting in a Q value for the MEMS sensor of about 65,000. Point 406 corresponds to a sensor chamber that is backfilled with an inert gas having a pressure of about 0.1 mTorr, resulting in a Q value for the MEMS sensor of about 78,000. Point 408 corresponds to a sensor chamber that is backfilled with a pressure of about 5 mTorr, resulting in a Q value for the MEMS sensor of approximately 67,000. Point 410 corresponds to a sensor chamber backfilled with a pressure of about 18 mTorr, resulting in a Q value for the MEMS sensor of approximately 45,000. Point 412 corresponds to a sensor chamber backfilled to a pressure of about 44 mTorr, resulting in a Q value for the MEMS sensor of approximately 30,000.

This illustrative graph may help determine the relationship between the Q value of a sensor and the chamber pressure associated with that Q value. By determining a desirable Q value of a particular sensor and/or a desirable ring-down time of the sensor and/or a desired sensitivity of a sensor, a corresponding pressure for the sensor chamber may be predetermined. Thus, the MEMS sensor package may be backfilled to the predetermined pressure of inert gas, as desired.

Having thus described the preferred embodiments of the present invention, those of skill in the art will readily appreciate that yet other embodiments may be made and used within the scope of the claims hereto attached. Numerous advantages of the invention covered by this document have been set forth in the foregoing description. It will be understood, however, that this disclosure is, in many respect, only illustrative. Changes may be made in details, particularly in matters of shape, size, and arrangement of parts without exceeding the scope of the invention. The invention's scope is, of course, defined in the language in which the appended claims are expressed.

1. A MEMS sensor package comprising:
a MEMS sensor;
a chamber for receiving the MEMS sensor; and
an inert gas backfilled into the chamber, the inert gas having a pressure.

2. The MEMS sensor package of claim 1 wherein the pressure of inert gas in the chamber is greater than a pressure of non-inert gas in the chamber.

3. The MEMS sensor package of claim 2 further comprising a getter situated inside the chamber, wherein the getter absorbs non-inert gas but does not significantly absorb inert gas.

4. The MEMS sensor package of claim 1 wherein the inert gas is argon.

5. The MEMS sensor package of claim 3 wherein the getter absorbs residual non-inert gas in the chamber and/or non-inert gas that leaks and/or out gases into the chamber.

6. The MEMS sensor package of claim 2 wherein the pressure of the inert gas is about 10 mTorr or more.

7. The MEMS sensor package of claim 1 wherein the MEMS sensor is a MEMS gyro sensor.

8. A method of providing a MEMS sensor, comprising:
providing a MEMS sensor into a chamber;
evacuating the chamber to a predetermined pressure;
backfilling the chamber with an inert gas; and
sealing the chamber.

9. The method of claim 8 wherein the MEMS sensor is a MEMS gyro sensor.

10. The method of claim 9 wherein the chamber is backfilled with a pressure of inert gas greater than a pressure of non-inert gas.

11. The method of claim 10 wherein the chamber is backfilled with 10 mTorr or more of inert gas.

12. The method of claim 11 wherein the inert gas is argon.

13. The method of claim 13 wherein the MEMS gyro sensor has an expected life of at least 15 years.

14. The method of claim 8 further comprising:
providing a getter in the chamber; and
activating the getter.

15. A method of setting a Q value for a MEMS sensor, wherein the MEMS sensor is housed in a chamber, the method comprising:
evacuating the chamber;
identifying a predetermined pressure that will produce a desired Q value for the MEMS sensor;
backfilling the MEMS sensor chamber with an inert gas to the predetermined pressure; and sealing the chamber.

16. The method of claim 15 further comprising the steps of:
providing a getter in the chamber that absorbs non-inert gasses but does not significantly absorb inert gases;
activating the getter.

17. The method of claim 15 wherein the identifying step comprises:
determining a desired ring-down time of the MEMS gyro sensor; and
determining a desired sensitivity of the MEMS gyro sensor.

18. The method of claim 15 wherein an expected useful life of the MEMS gyro sensor is 15 years or greater.

19. The method of claim 15 wherein the inert gas is argon.

20. The method of claim 15 wherein the MEMS sensor is a MEMS gyro sensor.
